(19) United States
(12) Patent Application Publication
(10) Pub. No.: US 2019/0393830 A1
(43) Pub. Date: Dec. 26, 2019

(54) Telescopic solar panel array

(71) Applicant: Robert E. Reid, JR., Shoreham, NY (US)

(72) Inventor: Robert E. Reid, JR., Shoreham, NY (US)

(21) Appl. No.: 15/932,473

(22) Filed: Mar. 3, 2018

(51) Int. Cl. H02S 30/20; H02S 20/32; F15B 15/14

(52) U.S. Cl. CPC H02S 30/20; F15B 15/14; H02S 20/32

(57) ABSTRACT

A telescopic retractable mast system for deploying a solar panel array comprising a one or more of masts, each mast comprising sections, means for retracting and extending each mast and means for mounting and deploying a plurality of solar panel thereon such that the solar panels are and may be adjustable as to maximize the electrical output therefrom. When in use, the mast system may be extended upwards to allow solar generation to take place and when conditions are not appropriate, such as inclement weather, the mast and therefore the solar panels may be retracted into a protected configuration, such as into an enclosure.

### CROSS-REFERENCE TO RELATED APPLICATION

This application claims the benefit of U.S. Provisional Application Ser. No. 62/600,770 filed Mar. 4, 2017.

### BACKGROUND OF THE INVENTION

The present invention relates to the art of telescopic masts having attached thereto a series of photovoltaic solar panels and more particularly to a system for retractably deploying multiple solar panels.

As the world looks to alternate source of energy, photovoltaic solar panels have come to the forefront. While these devices are simple to use, the amount of power produced is directly related to the square footage of the panels deployed, which consumes substantial square footage in the ground area in which the panels are to be deployed. Therefore, the ability to deploy multiple panels in the same ground area as typically occupied by a panel would be advantageous in areas of high electrical demand where there is reduced areas for deployment.

In addition, the ability to raise and lower these solar panel systems and to adjust the orientation of same will reduce the potential damage to the solar arrays from storms and other natural harm while allowing the array to adjust to capture the optimum effect of the sun's as the sun moves across the sky, thereby maximizing the electrical production of a given array.

Prior art attempts to reap these benefits have fallen short due to the lack of ability to deploy more then one panel. See for example U.S. Pat. Nos. 7,497,140 and 8,276,326.

These and other systems only employ one pole which even if it could contain a series of panels, would not be a stable solution for such a circumstance.

It has been estimated that under conventional circumstances, it takes solar panels deployed on an average of 5.25 acres of land to provide 1 megawatt of electrical power. A system such as described herein can produce a comparable amount to power in less than 1 acre.

Accordingly, there is the need to provide a mast system for deploying an array of solar panels in a substantially reduced ground area and which overcomes the above described defects while providing the benefits described herein.

### SUMMARY OF THE INVENTION

The present invention is specifically drawn to a system for deploying a series of solar panels having sufficiently large surface area while minimizing the area of the surface needed to deploy the panels. This will allow the installation of solar panels in smaller areas then heretofore possible. This feature is accomplished through the use of a one or more of telescopic mast, which may be extended and retracted, and upon which a series of solar panel arrays may be mounted and deployed for the generation of solar power in the extended mode and safely stored in the retracted mode.

In a preferred embodiment of the subject invention, the telescopic masts employ nested mast sections, each section being extendable out of an adjacent mast section such that the entire mast is extended. The extension is accomplished through the introduction of hydraulic fluid into the interior of each mast in a manner that is well known in the art. The extension of the masts may also be accomplished by employing electrical hoists, cable hoists, chain hoists and the like.

In accordance with the teaching of this invention, a scissor style lift may be substituted for the above described hydraulic mast. This will allow the solar panels to be deployed vertically above the surface on which the device of this invention is amounted but also as an angle to the surface but also horizontally along such surface.

Furthermore, as an alternative to mounting the present system onto a generally flat fixed surface, the system of the present invention may be mounted inside a container such that in the extended mode, the solar panels are deployed outside of the container but in the retracted mode, the system is whole contained within this container which may have a cover attached there over. In this way, the system may be safely contained for transport but also to protect from the elements in the case of inclement or other forms of severe weather or environmental conditions.

### BRIEF DESCRIPTION OF THE DRAWINGS

The invention may take form in certain components, structures and steps, the preferred embodiment of which is illustrated in the accompanying drawings, which show the following:

FIG. 1 is a front elevation view of the telescopic solar panel array in a fully extended view, having four solar panels and hydraulic masts in accordance with the preferred embodiment of the present invention;

FIG. 2. is a side-elevation view of the array of FIG. 1.

FIG. 3 is a front elevation view of the array of FIG. 1 in a fully retracted mode in accordance with the preferred embodiment of the present invention;

FIG. 4 is a side-elevation view of the array of FIG. 1 in a fully retracted mode.

FIG. 5 is a front elevation view of the telescopic solar panel array in a fully extended view, having eight solar panels and hydraulic pistons in accordance with the preferred embodiment of the present invention;

FIG. 6 is a side-elevation view of the array of FIG. 5;

FIG. 7 is a side-elevation view of the array of FIG. 5 in a fully retracted mode;

FIG. 8. Is a side view of an alternate embodiment of the present invention where the telescopic masts are substituted for by a scissor style lift and which also provides a storage container for the solar array when retracted;

FIG. 9 is a side view of the embodiment of FIG. 8 in the fully retracted mode.

FIG. 10 is a side view of the alternate embodiment of FIG. 8 extended at an angle from vertical;

FIG. 11 is a side view of the alternative embodiment of FIG. 10 in the fully retracted mode:

FIG. 12 is yet another embodiment of the present invention with the solar panels in a horizontal deployment;

FIG. 13 is a side view of the embodiment of FIG. 12 in a partially extended mode; and

FIG. 14 is side view of the embodiment of FIG. 12, full retracted into a container.

### DESCRIPTION OF THE PREFERRED EMBODIMENTS

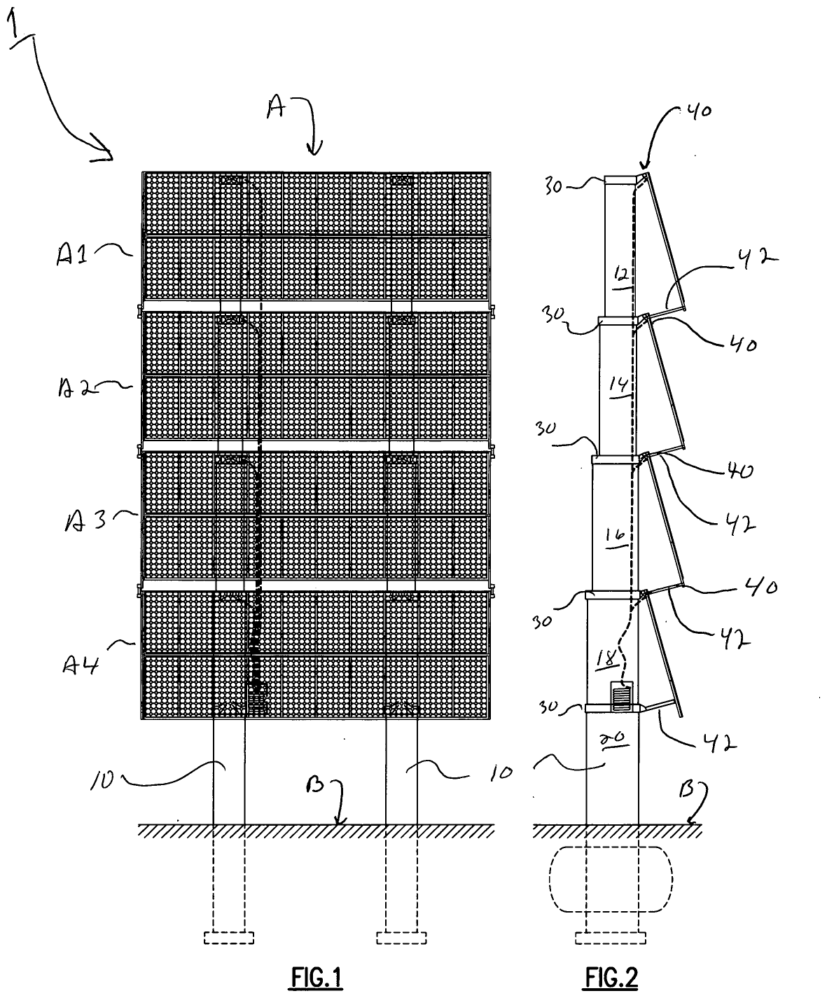

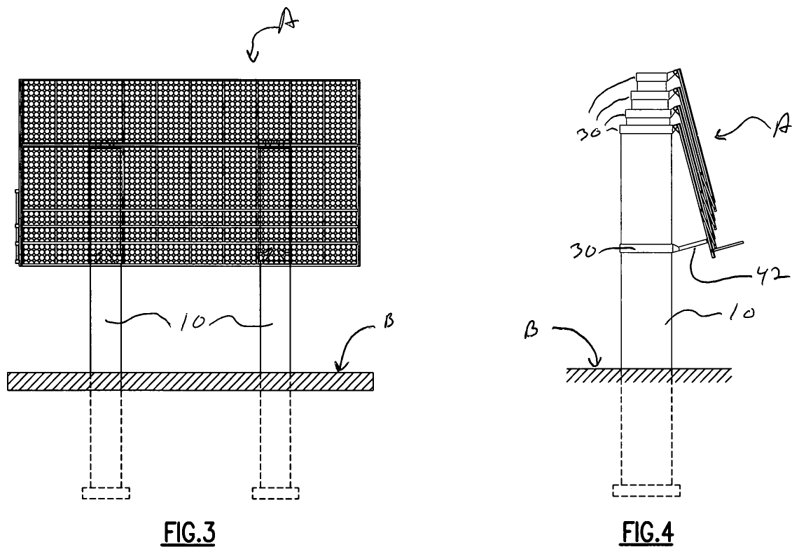

Referring to the drawings, which are for the purpose of illustrating preferred embodiments of the invention only, and not for the purpose of limiting same, FIG. 1 shows the subject system 1 in fully extended mode with four solar panels, A1 thru A4, each panel being attached to each of the telescoping masts 10. Each mast 10, which is immovably affixed at the bottom end thereof to a surface B in a generally perpendicular orientation, includes a plurality of interconnected, nested mast sections 12, 14, 16, 18 and 20 (better viewed in FIG. 2).

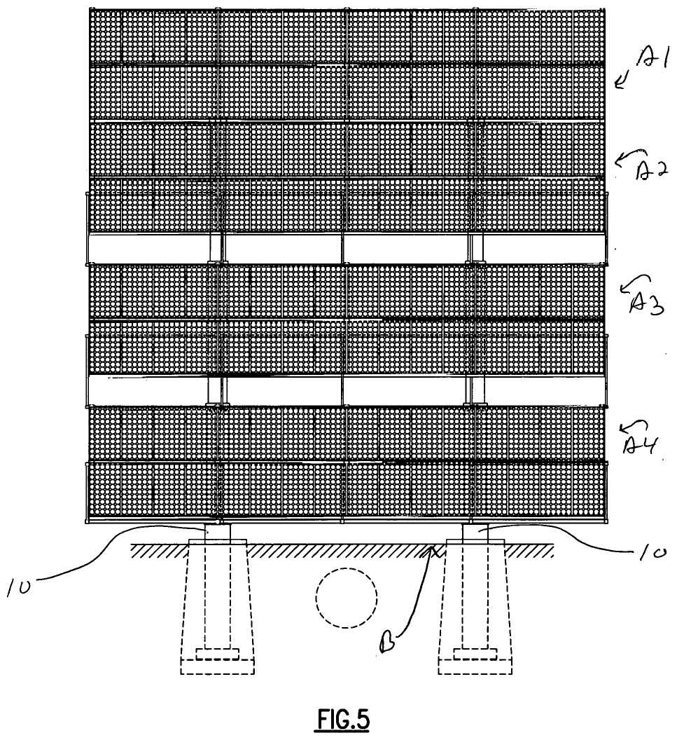

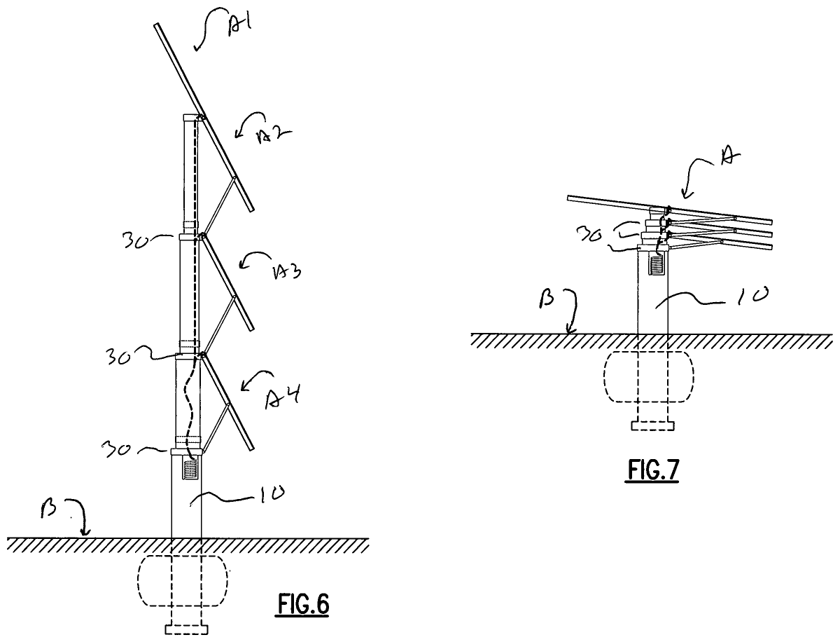

As indicated above, the system of the present invention may include more than four (4) solar panels, A1 thru A4. This is depicted in FIGS. 5, 6 and 7.

The mast sections 12, 14, 16, 18 and 20 are generally tubular and tapered and are sized such that a subsequent section fits into a prior section. Each mast section is further provided with a collar 30 at one end thereof such that when the next adjacent mast section is extended out therefrom, the collar 30 holds such subsequent mast section from coming out of the prior mast section completely.

Each mast 10 is most advantageously manufactured from high strength aluminum but within the scope of this invention, any suitable material may be employed within the scope of this invention.

Although only five (5) mast sections are shown, it will be understood that any number of mast sections may be employed within the scope of this invention, depending on the desired height to which the solar array may be raised, which is typically 20 feet in the retracted mode and 60-100 feet in the extended mode. However, this height may be more or less as may be required, within the scope of this invention.

The masts 10 of the present invention are extended and retracted by introducing and removing hydraulic fluid therefrom such that the nested mast sections 12, 14, 16, 18 and 20 each extend out of or retract into the next adjacent mast section but are preventing from coming out completely from the adjacent section by collar 30, such that in the fully extended mode, the mast is rigid and completely supportive of the solar panels. The hydraulic system that supports this operation is not shown but is believed to be well known in the industry.

As depicted in the FIGs., the top of each solar panel A is affixed to the mast 10 at various points along the length of the mast at a pivot 40 and at the bottom of each panel by an arm 42 which extends from the bottom of the solar panel A to a point on the mast in the same location as the pivot 40 on the panel below. The arm 42 may be adjusted in length such that the angle of the solar panel A relative to the horizontal axis of the mast 10 may be adjusted, as needed and required to maximize power production.

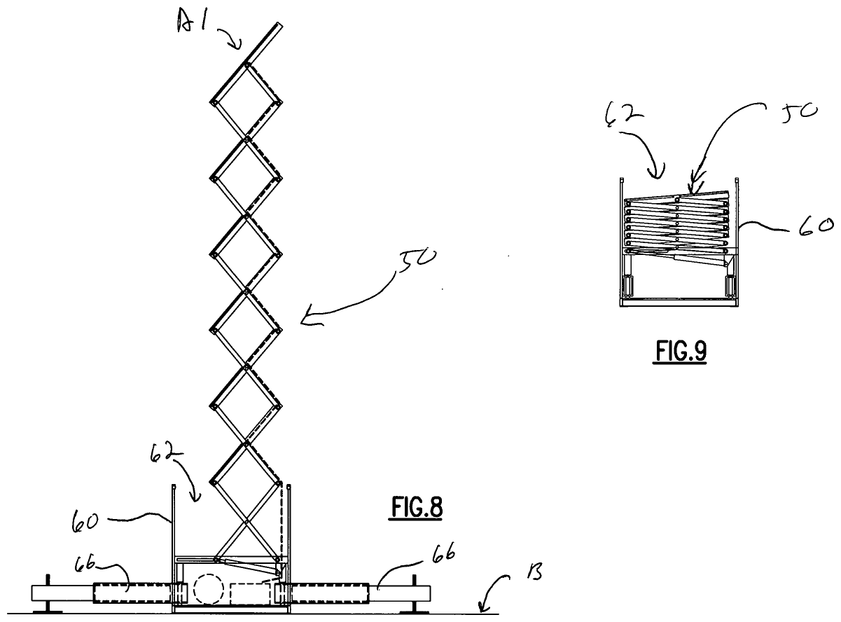

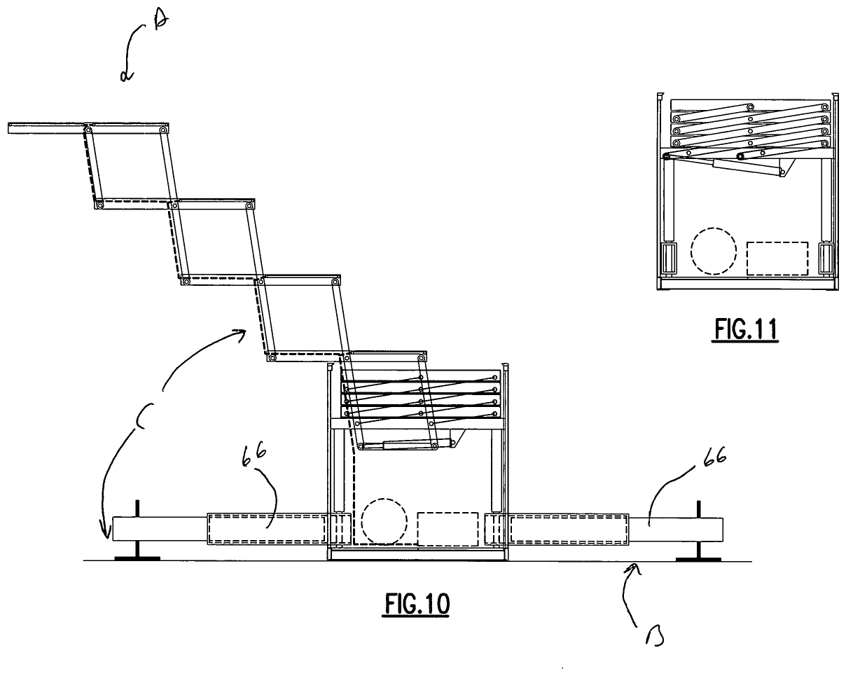

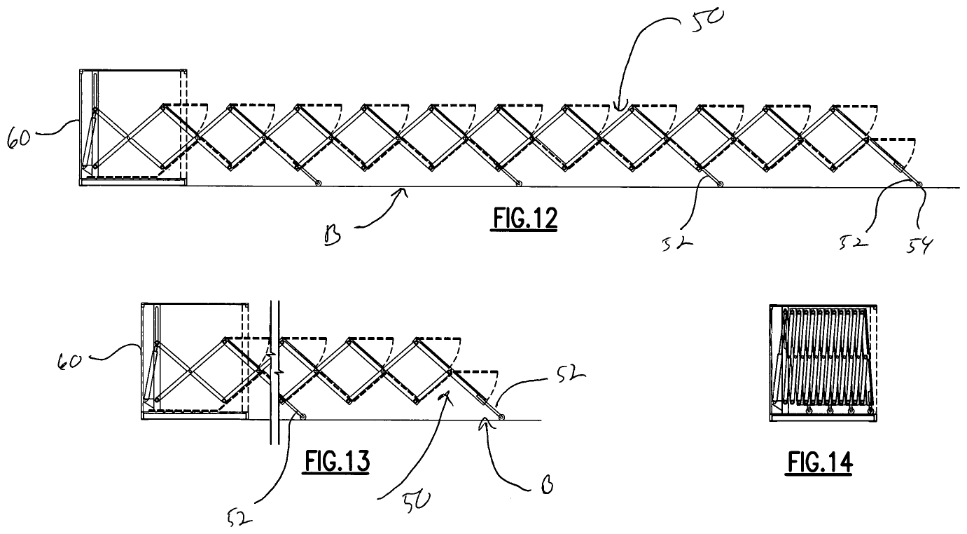

An alternate embodiment of the present invention is shown in FIG. 8, et seq, wherein a scissor type lift 50 is substituted for each of the above masts 10. This allows for more flexibility in the manner in which the solar panels A may be deployed. By employing the scissor lift technology, the system of the present invention may be deployed at an angle to the surface B to which the system 1 is affixed. For example, the system may be deployed at an angle C to the surface (FIG. 10) and may also be deployed parallel to such surface B in a horizontal orientation (FIG. 12).

In the horizontal orientation, the scissor style lift 50 is provided with one or more feet 52, each foot 52 including a wheel 54 at the end of same which contracts the surface B so that as the lift 50 is deployed is may easily roll over surface B.

Through out many of the FIGs., it is seen that the system 1 may be installed into a container 60 which container has an opening 62 on the top thereof. The system, when fully retracted, is contained wholly within the container 60 and the opening 62 may be fitted with a cover of some type (not shown). However, in the extended mode, the solar panels A of the subject invention are deployed wholly out of the container such that the solar panels A may be completely exposed to the sun.

The container 60 employed herein is for the purpose of transportation of the system 1 (i.e. the container may be fitted on the back of a truck) or in the alternative, for the protection of the system 1 from the elements. The container 60 when installed on a surface B may also include extendable feet 66 which may be extended out from the container and parallel to and in contact with surface B in order to aid in stabilizing the container 60 on the surface B.

Many modification sand variations of the present invention are possible in light of the above teachings. Therefore, within the scope of the appended claims, the present invention may be practiced other than as specifically described.

What is claimed is:

1. A mast system for retractably deploying a plurality of solar panels, comprised of:
One or more telescopic masts, each affixed at one end to a mounting surface and extending generally perpendicular from such surface;
a plurality of solar panels;
means for attaching each solar panel to different locations on said mast system; and
means for extending and retracting the mast system.

2. The assembly of claim 1, wherein each retractable mast consists of a plurality of mast sections each section nesting within the prior section and are operable in and out of each other to extend the mast to its full height.

3. The assembly of claim 1, wherein the panel mounting means allow each panel to be articulated at adjustable angles relative to the mast system.

4. The assembly of claim 2 where the mast is extended by hydraulic means.

5. The assembly of claim 3, where means are provided to automatically tract the sun.

6. The assembly of claim 1 wherein the masts are in the form of a scissor lift.

7. The assembly of claim 1 wherein the surface to which the assembly is mounted takes the form of a container, into which the entire assembly fits when fully retracted.

8. A method of deploying a plurality of solar panels, comprised of:
providing a retractable telescopic mast system;
attaching a plurality of solar panels at fixed points along the mast system; and
extending the mast upward such that each solar panel is set apart from each other panel such that each panel is exposed to the sun;
providing means for adjusting the angle of each solar array relative to the mast such that each array is perpendicular to the sun rays; and
providing means to retract the mast.
